(19) United States
(12) Patent Application Publication
(10) Pub. No.: US 2025/0058695 A1
(43) Pub. Date: Feb. 20, 2025

(54) Ratchet Load Binder Apparatus with Locking Sleeve and Methods of Using the Same

(71) Applicant: Holland, L.P., Crete, IL (US)

(72) Inventor: John B. Brewster, Homewood, IL (US)

(21) Appl. No.: 18/807,185

(22) Filed: Aug. 16, 2024

Related U.S. Application Data
(60) Provisional application No. 63/532,969, filed on Aug. 16, 2023.

(51) Int. Cl. B60P 7/08

(52) U.S. Cl. CPC B60P 7/083

(57) ABSTRACT

A rachet load binder having an improved locking sleeve apparatus is useful, for example, as tie-downs for heavy equipment on the decks of railcars, trucks, or other vehicles. More specifically, the telescoping ratchet load binder apparatus has an improved locking sleeve that aids in the prevention of loosening of the ratchet load binder apparatus when used to tie down heavy equipment, especially during transit. Methods of using the same are further provided.

### CROSS-REFERENCE TO RELATED APPLICATIONS

The present invention claims priority to U.S. Prov. Pat. App. No. 63/532,969, titled “Ratchet Load Binder Apparatus with Locking Sleeve and Methods of Using the Same,” filed Aug. 16, 2024, which is incorporated herein by reference in its entirety.

### TECHNICAL FIELD

The present invention relates to a rachet load binder apparatus having an improved locking sleeve apparatus useful, for example, as a tie-down for heavy equipment on the decks of railcars, trucks, or other vehicles. More specifically, the present invention relates to a ratchet load binder apparatus with an improved locking sleeve that aids in preventing the loosening of the ratchet load binder when used to tie down heavy equipment, especially during transit. Methods of using the same are further provided.

### BACKGROUND

Winches, turnbuckles, or tensioners are typically used in tie-down applications for heavy equipment. The transport of heavy equipment, such as military equipment, construction equipment, agricultural equipment, or other like equipment is frequently accomplished over rails, on vehicles such as trucks, via water transport, such as on rivers, canals, and/or seas or oceans. It is typically desirable to ensure that the heavy equipment is securely tied down so that the heavy equipment does not move or shift during transport thereof.

The heavy equipment is further typically positioned on a deck of a transporter, such as the deck of a cargo ship, railcar, truck or other like transporter, and lengths of chain are typically attached to the heavy equipment, or a support frame thereof, and tied down to the deck of the transporter. Frequently, chains of sufficient load-bearing capability are utilized to ensure that the chains securely hold the heavy equipment without breaking.

To ensure that the heavy equipment does not move or shift on the deck of the transporter, the chains may typically be tensioned via tensioners or winches. FIG. 1 illustrates a prior art telescoping ratchet load binder 10 that is generally used to tie down heavy equipment. The telescoping ratchet load binder 10 may be attached to a chain (not shown) for tensioning the chain as it is attached to the heavy equipment. The ratchet load binder tensioner 10 may further be interconnected to the deck (not shown) of a transporter, on an eyebolt 13 thereof and attached to the chain on a second eyebolt 14 thereof. The load binder body 12 may utilize adjustments to allow the ratchet load binder 10 to pull the chain (not shown) downwardly toward the deck (not shown) of the transporter, thereby tensioning the chain as it is attached to heavy equipment. These adjustments are described in U.S. Pat. No. 10,029,604, titled “Ratchet Load Binder Tie Down Apparatus and Methods of Using the Same,” issued on Jul. 24, 2018, which is incorporated herein by reference in its entirety.

The ratchet load binder 10, as illustrated in FIG. 1, further has a locking sleeve 11 that is shown in the unlocked position or, as illustrated in FIG. 2 in the locked position, that is used to rigidly hold the load binder body 12 to the first end eyebolt 13 preventing the loosening of the ratchet load binder tensioner 10. Specifically, the locking sleeve 11 includes windows or cut-outs 20 that may engage tabs or ears 21 that extend from or near the eyebolt 13, as shown in FIG. 2. Moreover, a passage 22 disposed in the sleeve 11 may slide over tab 23 on the lock load binder body 12, thereby preventing movement/rotation of components of the load binder 12 relative to the eyebolt 13. Thus, the locking sleeve 11 is used to ensure that the ratchet load binder 10 stays at its adjusted tie-down position. Loosening of the ratchet load binder 10 can be problematic, if not catastrophic, especially during the transport of heavy equipment.

During transport, especially when the ratchet load binder 10 is disposed in certain positions, the locking sleeve 11 may become loose and may slide longitudinally along the adjuster body 12, which may allow the binder 10 to loosen. To prevent such a possibility, wires (not shown) are used to tie the locking sleeve 11 to the tabs or ears 21 or other components thereof, thereby adding another layer of protection to prevent accidental or unintentional movement of the locking sleeve 11, which may lead to loosening of the ratchet load binder 10.

However, even with these apparently redundant protections, locking sleeves, as illustrated above in FIGS. 1 and 2, of ratchet load binders may still become loose during transport. A need, therefore, exists for improved ratchet load binder apparatuses. Moreover, a need exists for improved ratchet load binder apparatuses that provide protection against accidental or unintentional movement of the locking sleeve, especially during transport thereof. Specifically, a need exists for improved ratchet load binder apparatuses that ensure that the ratchet load binder apparatuses remain in position after being utilized to tie-down heavy equipment thereof.

Further, a need exists for improved ratchet load binder apparatuses having improved locking sleeves thereon. Specifically, a need exists for improved ratchet load binder apparatuses wherein the improved locking sleeves provide resistance to movement. More specifically, a need exists for improved ratchet load binder apparatuses wherein the improved locking sleeves further allow for movement by an operator when locking or unlocking.

### SUMMARY OF THE INVENTION

The present invention relates to a rachet load binder apparatus having an improved locking sleeve apparatus useful, for example, as a tie-down for heavy equipment on the decks of railcars, trucks, or other vehicles. More specifically, the present invention relates to a ratchet load binder apparatus with an improved locking sleeve that aids in preventing the loosening of the ratchet load binder when used to tie down heavy equipment, especially during transit. Methods of using the same are further provided.

To this end, in an embodiment of the present invention, a ratchet load binder tensioning apparatus is provided. The ratchet load binder tensioning apparatus comprises a body having an interior surface wherein a threaded body rotates and a connection element on an end of the threaded body; an ear extending at or near the connection element extending from the threaded body; a locking sleeve disposed over the body, wherein the locking sleeve has a cut-out configured to engage the ear on one end of the locking sleeve, and a passage disposed longitudinally, the passage engaging a tab extending from the body configured to allow the locking sleeve to slide longitudinally along the body; and a spring-loaded plunger extending from the tab and engaging engagement positions between a plurality of teeth disposed on an inside surface of the passage, the spring-loaded plunger resisting movement of the locking sleeve longitudinally along the body.

It is, therefore, an objective and advantage of the present invention to provide improved ratchet load binder apparatuses.

Moreover, it is an objective and advantage of the present invention to provide improved ratchet load binder apparatuses that provide protection against accidental or unintentional movement of the locking sleeve, especially during transport thereof.

Specifically, it is an objective and advantage of the present invention to provide improved ratchet load binder apparatuses that ensure that the ratchet load binder apparatuses remain in position after being utilized to tie-down heavy equipment thereof.

Further, it is an objective and advantage of the present invention to provide improved ratchet load binder apparatuses having improved locking sleeves thereon.

Specifically, it is an objective and advantage of the present invention to provide improved ratchet load binder apparatuses wherein the improved locking sleeves provide resistance to movement.

More specifically, it is an objective and advantage of the present invention to provide improved ratchet load binder apparatuses wherein the improved locking sleeves further allow for movement by an operator when locking or unlocking.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a perspective view of a prior art ratchet load binder with a locking sleeve in an unlocked position.

FIG. 2 illustrates a close-up perspective view of the prior art ratchet load binder with a locking sleeve in a locked position.

FIG. 3 illustrates a perspective close-up view of a ratchet load binder having a locking sleeve disposed in a locked position over the ratchet load binder in an embodiment of the present invention.

FIG. 4 illustrates a cross-sectional view of the ratchet load binder having a locking sleeve disposed in un unlocked position in an embodiment of the present invention.

### DETAILED DESCRIPTION OF THE PRESENTLY PREFERRED EMBODIMENTS

The present invention relates to a rachet load binder apparatus having an improved locking sleeve apparatus useful, for example, as a tie-down for heavy equipment on the decks of railcars, trucks, or other vehicles. More specifically, the present invention relates to a ratchet load binder apparatus with an improved locking sleeve that aids in preventing the loosening of the ratchet load binder when used to tie down heavy equipment, especially during transit. Methods of using the same are further provided.

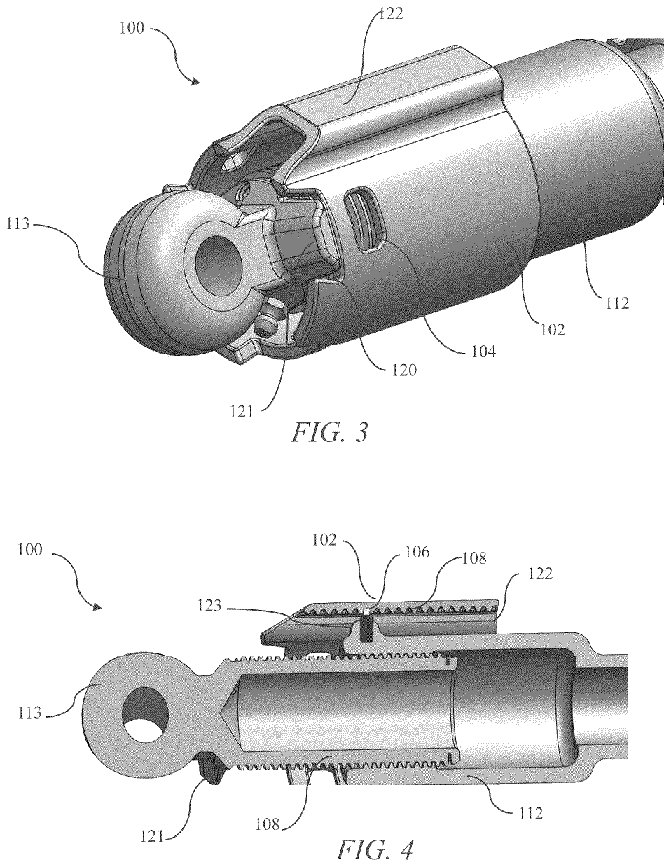

Now referring to the figures, wherein like numerals refer to like parts, FIG. 3 illustrates a perspective view of a telescoping ratchet load binder apparatus 100 having a locking sleeve 102 in a locked position in an embodiment of the present invention. Likewise, FIG. 4 illustrates a cross-sectional view of the telescoping ratchet load binder apparatus 100 with the locking sleeve 102 in the unlocked position.

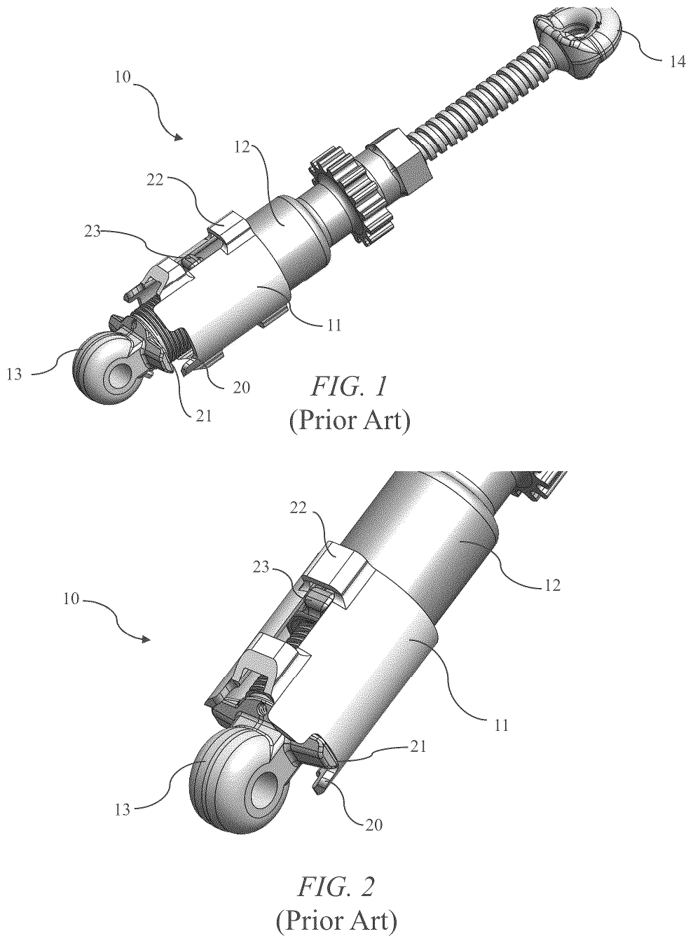

As shown in FIG. 3, the telescoping ratchet load binder apparatus 100 may have a body 112 and an eyelet 113, and adjustments may be made to it for lengthening and/or shortening the same, as described with respect to FIGS. 1 and 2. In FIG. 3, the slidable locking sleeve 102 may be disposed over the ratchet load binder body 112 and may slide longitudinally along the ratchet load binder body 112 to lock the locking sleeve in place. Specifically, the locking sleeve 102 may have cut-outs 120 that may engage tabs or ears 121 that may extend from or near the eyelet 113. In addition, the locking sleeve 102 may have one or more windows 104 that may be utilized to thread wire or another locking element (not shown) therethrough so that the locking sleeve is prevented from moving once in the locked position, as illustrated in FIG. 3.

Disposed on the ratchet load binder body 112 may be a tab 123, as shown in FIG. 4, that may extend from the body 112 and engage a passage 122 that may be disposed in the locking sleeve 102. The tab 123 may further hold the locking sleeve 102 in place, thereby preventing rotating of the body 112 when the locking sleeve 102 is in the locked position, as illustrated in FIG. 3. The tab 123 may further have a spring-loaded plunger 106 that may engage a plurality of teeth 108 that may be disposed on an inside surface of the locking sleeve 102, specifically on an inside surface of the passage 122. As the locking sleeve 102 moves longitudinally along the body 112, the spring-loaded plunger 106 may move in and out thereby engaging engagement positions between the teeth 108 along the length of the inside surface of the passage 122. Manually moving the locking sleeve 102 may provide sufficient force to cause the spring-loaded plunger 106 to engage and move along the engagement positions between the teeth 108. However, when placed in the locking position, as shown in FIG. 3, the spring-loaded plunger 106 may engage a specific engagement position between the teeth 108 and may, thus, provide additional resistance to movement of the locking sleeve 102. Therefore, the locking sleeve 102 may remain in the locked position over the body 112 of the ratchet load binder apparatus 100 and may further be prevented in disengaging from the locking position during transport.

When in use, the locking sleeve 102 may engage the ears 121 at or near the eyelet 113 and may further engage the tab 123 and spring-loaded plunger 106 that may extend from the ratchet load binder body 112, thereby preventing rotation of threaded body 108 within the ratchet load binder body 112. Therefore, because the locking sleeve 102 remains in a locked position due to the engagement of the spring-loaded plunger 106 to one of the engagement positions between the teeth 108 of the passage 122 of the locking sleeve 102, the ratchet load binder apparatus 100 may remain steadfastly attached to the vehicle deck (not shown) thereby rigidly holding the heavy machinery (not shown) disposed thereon without loosening of the same, especially during transport thereof.

It should be noted that various changes and modifications to the presently preferred embodiments described herein will be apparent to those skilled in the art. Such changes and modifications may be made without departing from the spirit and scope of the present invention and without diminishing its attendant advantages.

1: A ratchet load binder tensioning apparatus comprising:
a main body having an interior surface wherein a threaded body rotates;
a connection element on an end of the threaded body;
an ear extending at or near the connection element extending from the threaded body; and
a locking sleeve disposed over the main body, wherein the locking sleeve has a cut-out configured to engage the ear on one end of the locking sleeve, and a passage disposed longitudinally, the passage engaging a tab extending from the main body configured to allow the locking sleeve to slide longitudinally along the main body, wherein the tab is configured to engage an engagement position on an inside surface of the passage.

2: The ratchet load binder tensioning apparatus of claim 1 wherein the locking sleeve resists movement relative to the main body when the tab engages the engagement position disposed on the inside surface of the passage.

3: The ratchet load binder tensioning apparatus of claim 1 further comprising:
a spring-loaded plunger extending from the tab and configured to engage the engagement position disposed on the inside surface of the passage.

4: The ratchet load binder tensioning apparatus of claim 3 wherein the spring-loaded plunger resists movement of the locking sleeve longitudinally along the main body.

5: The ratchet load binder tensioning apparatus of claim 1 wherein the engagement position is between a plurality of teeth on the inside surface of the passage.

6: The ratchet load binder tensioning apparatus of claim 1 further comprising:
a plurality of engagement positions along the inside surface of the passage.

7: The ratchet load binder tensioning apparatus of claim 6 wherein each of the plurality of engagement positions is between two teeth.

8: The ratchet load binder tensioning apparatus of claim 6 wherein the tab is configured to engage one of the plurality of engagement positions on the inside surface of the passage.

9: The ratchet load binder tensioning apparatus of claim 1 wherein the connection element is an eyelet.

10: The ratchet load binder tensioning apparatus of claim 1 wherein the apparatus alternately lengthens and shortens by rotating the threaded body within the main body.

11: The ratchet load binder tensioning apparatus of claim 1 wherein the apparatus resists lengthening or shortening when the cutout on the locking sleeve engages the ear and the tab engages the engagement position on the inside surface of the passage.

12: A method of using a load binder ratchet tensioning apparatus comprising the steps of:
providing a ratchet load binder tensioning apparatus comprising a main body having an interior threaded surface wherein a threaded body rotates, a connection element on an end of the threaded body, an ear extending at or near the connection element extending from the threaded body, and a locking sleeve disposed over the body, wherein the locking sleeve has a cut-out configured to engage the ear on one end of the locking sleeve and a passage disposed longitudinally, the passage engaging a tab extending from the main body configured to allow the locking sleeve to slide longitudinally along the main body, wherein the tab is configured to engage an engagement position on an inside surface of the passage; and
alternately lengthening and shortening the ratchet load binder tensioning apparatus by rotating the threaded body inside the main body.

13: The method of claim 12 further comprising the step of:
moving the locking sleeve longitudinally relative to the main body and engaging the ear of the threaded body with the cut-out of the main body.

14: The method of claim 13 wherein the threaded body resists movement relative to the main body when the ear of the threaded body is engaged with the cut-out of the main body.

15: The method of claim 12 further comprising the step of:
engaging the tab on the main body with the engagement position on the inside surface of the passage.

16: The method of claim 12 wherein the locking sleeve resists movement relative to the main body when the tab on the main body is engaged with the engagement position on the inside surface of the passage.

17: The method of claim 12 further comprising the steps of:
moving the locking sleeve longitudinally relative to the main body and engaging the ear of the threaded body with the cut-out of the main body; and
engaging the tab on the main body with the engagement position on the inside surface of the passage.

18: The method of claim 17 wherein the threaded body resists movement relative to the main body when the ear of the threaded body is engaged with the cut-out of the main body and further wherein the locking sleeve resists movement relative to the main body when the tab on the main body is engaged with the engagement position on the inside surface of the passage.

19: The method of claim 12 wherein a spring-loaded plunger extends from the tab.

20: The method of claim 19 wherein the spring-loaded plunger engages the engagement position disposed on the inside surface of the passage.
